(19) United States
(12) Patent Application Publication
(10) Pub. No.: US 2008/0007041 A1
(43) Pub. Date: Jan. 10, 2008

(54) Locking device for restraint belts, particularly for motor vehicle safety seats for children

(75) Inventor: Paolo NOVARA, Torino (IT)

Correspondence Address: SUGHRUE MION, PLLC, 2100 PENNSYLVANIA AVENUE, N.W., SUITE 800, WASHINGTON, DC, 20037, US

(73) Assignee: NOVARACE S.R.L., Torino (IT)

(21) Appl. No.: 11/772,937

(22) Filed: Jul. 3, 2007

(30) Foreign Application Priority Data
Jul. 4, 2006 (IT) TO2006A000492

(51) Int. Cl. B60R 22/34; B60R 22/08; B60R 22/10

(52) U.S. Cl. 280/803; 297/479

(57) ABSTRACT

The buckle includes a metal body and a snap coupling mechanism for releasable connection of a pair of tongue elements to the metal body. The snap coupling mechanism comprises a release button which can be operated by the user to push the tongue elements out of the metal body, a locking plate which can assume a locked position in which it retains the tongue elements in the metal body and a released position in which it disengages the tongue elements from the metal body, a release member which can be operated via the release button to move the locking plate into the released position, and a pair of sliders for resiliently opposing the insertion of the tongue elements into the metal body. According to the invention, the metal body is made as a single sheet metal piece obtained by blanking and folding.

### BACKGROUND OF THE INVENTION

The present invention relates to a locking device for restraint belts, particularly for motor vehicle safety seats for children, and more specifically to a buckle for a locking device for restraint belts.

Restraint belts for motor vehicle safety seats for children usually comprise three branches, which can be releasably connected to each other by means of a locking device comprising a buckle attached to the free end of one of the branches and two tongue-like coupling elements, which are attached to the free ends of the other two branches and are intended to be inserted and locked in a body of the buckle to ensure that the belts are locked around the trunk of the child accommodated in the seat.

A locking device for restraint belts of the above-identified type is known for example from International Patent Application WO2005/000063.

### SUMMARY OF THE INVENTION

It is an object of the present invention to provide a buckle for a locking device for restraint belts with three branches, particularly for motor vehicle safety seats for children, having a simple and strong structure, a safe and reliable operation and a reduced cost.

This object is fully achieved according to the present invention by virtue of a buckle for a locking device for restraint belts having the features indicated in independent claim 1.

Advantageous embodiments of the invention are defined by the dependent claims.

### BRIEF DESCRIPTION OF THE DRAWINGS

The features and the advantages of the invention will become clear from the following detailed description, given purely by way of non-limiting example with reference to the appended drawings, in which:

FIG. 1 is a perspective view of a locking device for restraint belts with three branches, particularly for motor vehicle safety seats for children, according to a preferred embodiment of the invention;

FIG. 2 is a plan view of the locking device of FIG. 1, in which both the buckle and the tongue elements are deprived of an outer casing of plastic material;

FIGS. 3 to 5 are perspective views which show the coupling mechanism of the locking device of FIG. 1 and in which one or more components are each time omitted;

FIG. 6 is a perspective view of the metal body of the buckle of the locking device of FIG. 1;

FIG. 7 is a perspective view of the locking plate of the coupling mechanism of the locking device of FIG. 1;

FIG. 8 is a perspective view of the release member of the coupling mechanism of the locking device of FIG. 1;

FIG. 9 is a perspective view of a slider of the coupling mechanism of the locking device of FIG. 1;

FIG. 10 is a perspective view of the metal cores of the two tongues of the locking device of FIG. 1; and

FIG. 11 is a perspective view of the locking plate of the coupling mechanism of a locking device for restraint belts with three branches, particularly for motor vehicle safety seats for children, according to an alternative embodiment of the invention.

### DETAILED DESCRIPTION OF THE PREFERRED EMBODIMENTS

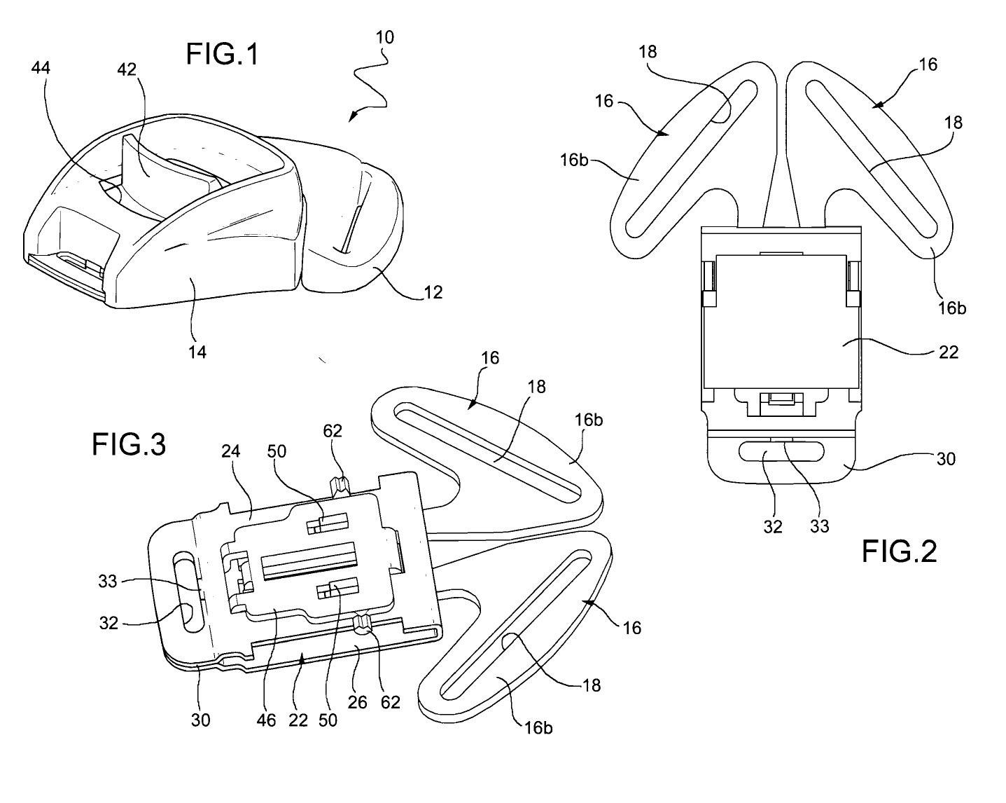

With reference first to FIG. 1, a locking device for restraint belts with three branches, particularly for motor vehicle seats for children, is generally indicated 10 and basically comprises a pair of tongue elements 12 (hereinafter simply referred to as tongues) intended to be attached each to a free end of a respective belt branch (not shown), and a buckle 14 intended to be attached to a free end of the third belt branch (also not shown). In FIG. 1, the locking device 10 is shown in the closed state, in which the two tongues 12 are inserted and locked in the buckle 14.

Each tongue 12 includes a metal core 16, which can be seen in FIGS. 2, 3 and 10, made as a plate element integrally forming a stem portion 16a adapted to be inserted and locked in the buckle 14, and an attachment portion 16b in which a slot 18 is formed for attachment of the tongue to the free end of the corresponding belt branch. The stem portion 16a of the metal core 16 of each tongue 12 further forms at its free end a catch 20, which extends perpendicularly to the stem portion 16a on the opposite side of the attachment portion 16b. The metal core 16 is fully covered by a coating of plastic material or rubber, advantageously obtained by overmoulding of this material on the metal core.

The buckle 14 includes a metal body 22, which can be seen in its entirety in FIG. 6, advantageously made as a single piece of sheet metal obtained by blanking and folding. Like the metal core 16 of the tongues 12, also the metal body 22 of the buckle 14 is fully covered by a coating of plastic material or rubber, advantageously obtained by overmoulding.

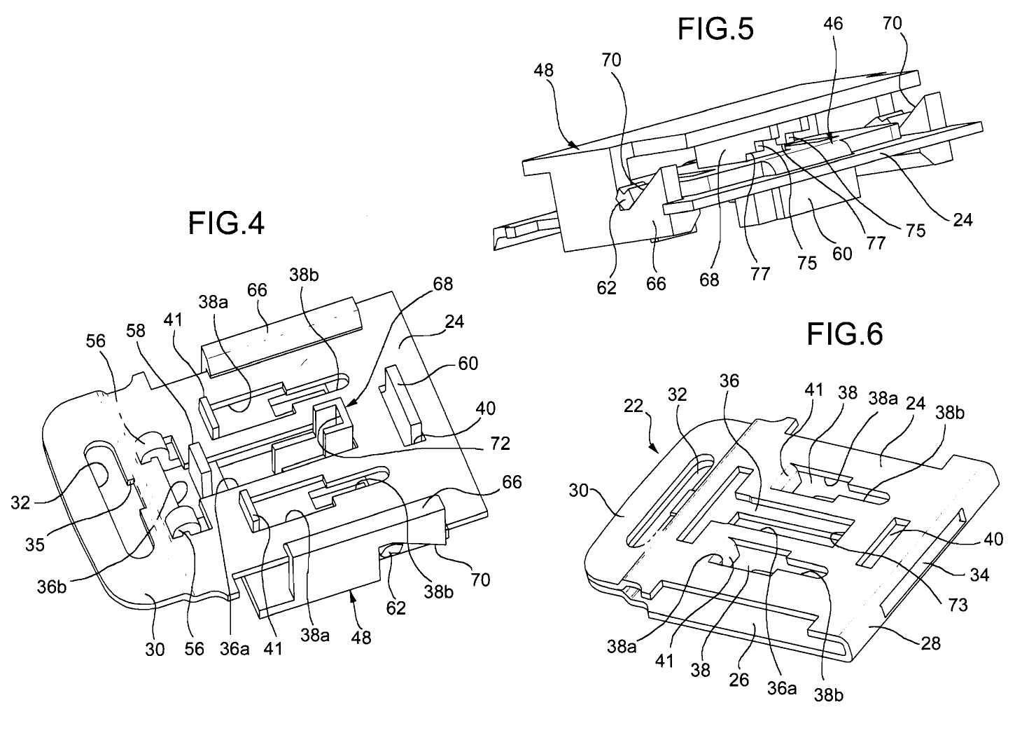

The metal body 22 includes an upper plate 24 and a lower plate 26 (wherein the terms “upper” and “lower” are given with reference to the orientation of the buckle as shown in FIG. 1) which extend parallel to and spaced from each other and are interconnected at an end by a connecting portion 28 perpendicular thereto. The two plates 24 and 26 form at the opposite end respective attachment extensions 30, in each of which a slot 32 is formed for fixing the buckle 14 to the respective belt branch. The two plates 24 and 26 are also connected to each other in the area of the attachment extensions 30, preferably by caulking a catch 33 (FIGS. 2 and 3), which is formed by the lower plate 26 in the illustrated example, in a notch 35 (FIG. 4) provided in the upper plate 24 along an edge of the slot 32. The connecting portion 28 has a rectangular opening 34, through which the catches 20 of the tongues 12 are inserted inside the metal body 22. The upper plate 24 has a central T-like opening 36 including a longitudinal branch 36a, which extends along the direction of insertion of the tongues 12 (hereinafter referred to as longitudinal direction), and a transverse branch 36b, which extends from the end of the longitudinal branch 36a facing the slot 32. The upper plate 24 further has a pair of side openings 38, which extend parallel to the longitudinal direction, on opposite sides of the central opening 36, and are each formed by a rectangular portion 38a and by an extension 38b of smaller width than the rectangular portion 38a. A lug 41 bent at a right angle to the upper plate 24 extends from the edge of the rectangular portion 38a of each side opening 38 opposite to the extension 38b towards the lower plate 26. Each lug 41 serves as an abutment element for a spring (not shown), as will be explained further on. The upper plate 24 further has a rectangular opening 40 extending perpendicular to the longitudinal direction in the vicinity of the through opening 34. All the above-mentioned openings 34, 36, 38 and 40 are made as through openings.

The snap coupling mechanism for releasable connection of the two tongues 12 to the buckle 14 will be described now with reference in particular to FIGS. 3, 4 and 5.

The snap coupling mechanism comprises first of all a release button 42 received in a seat 44 formed on the upper face of the buckle 14 so as to be slidable in the longitudinal direction. The release button 42 is held by a spring (not shown) in a locked position, in which the tongues 12 are locked in the buckle 14, and can be moved by the user against the elastic force of the aforesaid spring in a released position, in which the tongues 12 are pushed out of the buckle 14.

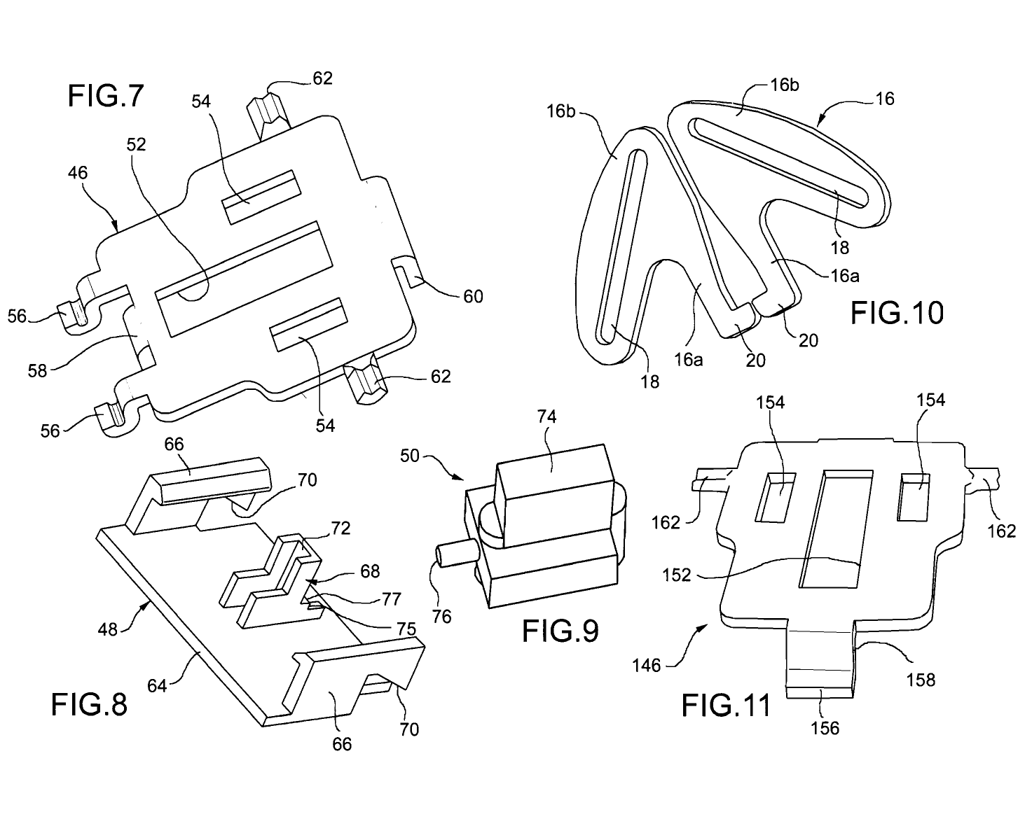

The snap coupling mechanism further comprises a locking plate 46, a release member 48 and a pair of sliders 50 illustrated in FIGS. 7, 8 and 9, respectively.

The locking plate 46 is a plate-like element of generally rectangular shape, preferably made of metal, for example of steel, so as to ensure the required mechanical strength. The locking plate 46 has a central slot 52 extending in the longitudinal direction, and a pair of side slots 54 extending parallel to the central slot 52 on opposite sides thereof. The length of the two side slots 54 is smaller than that of the central slot 52. The locking plate 46 forms at an end thereof a pair of articulation appendages 56, which in the assembled condition (see in particular FIGS. 3 and 4) engage in the transverse branch 36b of the opening 36 to allow the locking plate 46 to swing about an axis of rotation perpendicular to the longitudinal direction. A stop tab 58 extends perpendicular to the locking plate 46 between the two articulation appendages 56 and is aligned with the central slot 52. The stop tab 58 forms a first abutment surface for the spring of the release button 42. A locking tab 60 extends perpendicular to the locking plate 46 on the opposite side of the stop tab 58 and serves to restrain the catches 20 in the longitudinal direction when the coupling mechanism is in the locked position. The locking plate 46 is further provided with a pair of peg members 62 projecting from opposite edges of the plate, perpendicular to the longitudinal direction, approximately at the ends of the slots 52 and 54 facing towards the locking tab 60. Advantageously, the locking plate 46 is made as a single piece with the articulation appendages 56, the stop tab 58, the locking tab 60 and the peg members 62.

The release member 48 is preferably made of plastic material in order to reduce the overall weight of the buckle, and is rigidly connected to the release button 42 to be moved in the longitudinal direction between the aforesaid locked and released positions. Advantageously, the release member 48 is made as a single piece with the release button 42. The release member 48 comprises a plate 64 of generally rectangular shape, a pair of actuating elements 66 projecting from opposite edges of the plate 64 perpendicular to the plate itself, and a stop element 68 projecting from the centre of the plate 64 on the same side of the actuating elements 66. Each of the actuating elements 66 has a slanted control surface 70, along which a respective peg member 62 of the locking plate 46 slidably engages. As shown in FIG. 4, in the assembled condition the stop element 68 slidably engages in the longitudinal branch 36a of the central T-like opening 36 of the upper plate 24 of the metal body 22. The stop element 68 has a transverse wall 72 which provides on the side facing towards belt branch a second abutment surface for the spring of the release button 42 opposite to the aforesaid first abutment surface formed by the stop tab 58, and on the side facing towards the tongues 12 a stop surface cooperating with a bottom side 73 (FIG. 6) of the longitudinal branch 36a of the central T-like opening 36 so as to define a travel limit position for the release member 48, and hence for the release button 42. On the side of the transverse wall 72 facing towards the bottom side 73 of the longitudinal branch 36a of the central T-like opening 36, the release member 48 forms a pair of step-like portions 75 (FIGS. 5 and 8) serving to avoid inadvertent release of the coupling mechanism due to small longitudinal displacements of the release button induced by abrupt accelerations or decelerations of the vehicle, as will be better explained in the following part of the description.

The two sliders 50 serve to oppose the insertion of the tongues 12 into the buckle 14 during the phase of fastening the belts and to push the tongues 12 out of the buckle 14 during the phase of unfastening the belts. Each slider 50 has a substantially parallelepiped shape and such sizes that it can be passed through the rectangular portion 38a of the respective side opening 38 of the upper plate 24 of the metal body 22. In the assembled condition, each slider 50 is arranged between the two plates 24 and 26 of the metal body 22 so as to be slidable parallel to the longitudinal direction. The sliding of each slider 50 is guided by a guide appendage 74 extending upwards from the slider and slidably engages in the extension 38b of the respective side opening 38. The guide appendages 74 of the sliders 50 have such a height that in the locked position of the coupling mechanism (FIG. 3) they project from the upper plate 24 of the metal body 22 and engage each in the respective side slot 54 of the locking plate 46. Each slider 50 is urged by a respective spring (not shown) in the opposite direction to the direction of insertion of the tongues 12 into the buckle 14, the guide appendage 74 being in abutment against the bottom of the extension 38b of the respective side opening 38 of the metal body 22. The spring acting on each of the two sliders 50 is for example a cylindrical helical spring, which is mounted at the end facing towards the slider around a pin member 76 projecting from the slider and serving as a guide. Preferably, the guide appendage 74 and the pin member 76 are integrally formed with the respective slider 50 and are made of plastic material.

The operation of the snap coupling mechanism illustrated above in structural terms will be described now.

In the locked position shown in FIG. 3, the stem portions 16a of the two tongues 12 are inserted through the opening 34 of the metal body 22 of the buckle 14 and the catches 20 of the two tongues 12 are longitudinally restrained by the locking tab 60 of the locking plate 46. The locking plate 46 rests on the upper plate 24 of the metal body 22. The release member 48 is held by the respective spring in a tongue-side travel limit position, in such a manner that the peg members 62 of the locking plate 46 are in the lowest point of the respective slanted control surfaces 70 of the release member 48. Also the sliders 50 are held by the respective springs in a tongue-side travel limit position, in such a manner that the respective' guide appendages 74 engage not only in the side openings 38 of the upper plate 24 of the metal body 22, but also in the side slots 54 of the locking plate 46.

If at this point the release button 42 is urged towards the released position, in the illustrated example of embodiment in the same direction as that of insertion of the tongues 12 into the buckle 14, the release member 48 drivingly connected thereto moves in the same direction and causes, due to the peg members 62 of the locking plate 46 sliding along the slanted control surfaces 70, the locking plate 46 to move upwards from the upper plate 24 of the metal body 22 by swinging about the axis of rotation defined by the two articulation appendages 56. The upward movement of the locking plate 46 causes the disengagement of the catches 20 of the tongues 12 from the locking tab 60 on the one hand and the disengagement of the sliders 50 from the respective side slots 54 of the locking plate 46 on the other. Accordingly, the sliders 50 are urged by the respective springs towards the tongues 20 into the travel limit position defined by the bottom of the extensions 38b of the side openings 38 and thus cause the tongues 12 to be pushed out of the buckle 14.

As mentioned above, the function of the two step-like portions 75 of the stop element 68 is to avoid inadvertent release of the coupling mechanism due to small longitudinal displacements of the release button 42 induced by abrupt accelerations or decelerations of the vehicle. To this end, each step-like portion 75 forms a retaining flat surface 77 which extends parallel to the plate 64 of the release member 48 and has a longitudinal size of some millimeters, typically two or three millimeters. As shown in FIG. 5, in the locked position each retaining surface 77 faces towards, or better is in contact with, the locking plate 46. In this way, the upward movement of the locking plate 46 and hence the release of the coupling mechanism are avoided. This applies until the two retaining surfaces 77 are at least partially overlapped to the locking plate 46, i.e. in case of small displacements (in the order of two or three millimeters) of the release member 46, such as those which might be induced by abrupt accelerations or decelerations of the vehicle on which the safety seat is mounted.

The possibility to insert the tongues 12 into the buckle 14 again is ensured by the fact that the two sliders 50, which are urged to the aforesaid travel limit position by the respective springs, remain arranged below the locking plate 46, thereby preventing this latter from moving downwards and hence the locking tab 60 from obstructing the insertion of the stem portions 16a of the tongues 12 into the inside of the metal body 22 through the opening 34. Upon insertion into the metal body 22, the tongues 12 clash with the sliders 50 and urge them in the direction of insertion against the action of the respective springs. In this way, as soon as the guide appendages 74 of the sliders 50 are wholly arranged below the respective side slots 54 of the locking plate 46, this latter can move downwards again swinging about the axis of rotation defined by the articulation appendages 56. The locking tab 60 is therefore urged to the inside of the metal body 22 again and can thus restrain the catches 20 of the two tongues 12.

As will be understood in the light of the preceding description, a locking device according to the invention is very easy and economical to manufacture. In particular, the metal body of the buckle can be advantageously manufactured by simple blanking, folding and caulking (or equivalent joining method) operations from a sheet metal blank.

Moreover, thanks to the particular configuration of the metal body and of the locking plate, these two components define an intrinsically very stiff structure and can therefore be produced with the use of a thin sheet of non- hardened steel. This allows on the one hand to reduce the overall weight of the buckle, due to the reduced thickness of the steel sheet, and on the other to reduce the manufacturing costs and to make the manufacturing process easier, since a hardening treatment is no more required. The possibility to avoid the hardening treatment of the material of the body and of the locking plate allows also to meet more easily the dimensional and geometrical tolerances of those component, since, as is known, hardening produces deformations in the component being treated.

Moreover, the particular design of the metal body allows to assemble by gravity the various components of the coupling mechanism and hence to make the manufacturing of the buckle automatic.

Naturally, the principle of the invention remaining unchanged, the embodiments and constructional details may vary widely with respect to those described and illustrated purely by way of non-limiting example.

For example, according to a non-illustrated variant of embodiment, the assembly formed by the release button and by the release member may be hinged to the buckle body so as to swing about a transverse horizontal axis, rather than being longitudinally slidable.

The above-described buckle is conceived to meet the European regulations, which prescribe the possibility to insert only the two tongues together, instead of one single tongue at a time, into the buckle body. However, the buckle can be easily adapted to the regulations of the United States, which on the contrary provide for the possibility to insert also one single tongue at a time into the buckle body. To this end, it suffices to replace the coupling plate 46 shown in FIG. 7 with the coupling plate 146 shown in FIG. 11. In FIG. 11, the parts of the coupling plate which are identical or corresponding to those of the coupling plate of FIG. 7 have been designated with the same reference numerals, increased by one hundred. As can be immediately noticed from the comparison between the two figures indicated above, the coupling plate 146 of FIG. 11 differs from the coupling plate 46 of FIG. 7 substantially only in that the two articulation appendages 56 are omitted. On the other hand, there is provided only one articulation appendage 156 which is arranged in a transversely central position and advantageously extends from the free edge of the stop tab 158. The fact that only one central articulation appendage is provided allows the locking plate 146 to swing also about a longitudinal axis, as required when only one of the two tongues is inserted into the buckle body.

What is claimed is:

1. A buckle for a locking device for restraint belts, particularly for motor vehicles safety seats for children, including a metal body and a snap coupling mechanism for releasable connection of a pair of tongue elements to the metal body, wherein the metal body is made as a single sheet metal piece obtained by blanking and folding.

2. The buckle of claim 1, wherein a coating of plastic material or rubber is overmoulded over the metal body.

3. The buckle of claim 1, wherein the metal body includes an upper plate and a lower plate, which extend parallel to and spaced form each other and form at a first end thereof respective attachment extensions each having a slot for attachment of the buckle to a belt branch, and a connecting portion which extends perpendicular to the plates connecting them at the end opposite to the aforesaid first end.

4. The buckle of claim 3, wherein the upper plate and the lower plate are also connected to each other in the area of the attachment extensions by means of a catch formed by one of said plates.

5. The buckle of claim 3, wherein the connecting portion of the metal body has a through opening, through which the tongue elements can be inserted.

6. The buckle of claim 3, wherein the upper plate of the metal body has a plurality of through openings in which the components of the snap coupling mechanism are inserted or engage, in such a manner that said components can be fitted by gravity in the metal body.

7. The buckle of claim 1, wherein the snap coupling mechanism comprises a release button which can be operated by the user to push the tongue elements out of the metal body, a locking plate which can assume a locked position in which it retains the tongue elements in the metal body and a released position in which it disengages the tongue elements from the metal body, a release member operable via the release button to move the locking plate to the released position, and a pair of sliders for resiliently opposing the insertion of the tongue elements into the metal body.

8. The buckle of claim 7, wherein the release button and the release member are formed as a single piece.

9. The buckle of claim 7, wherein the release button and the release member are slidable in the direction of insertion of the tongue elements into the metal body.

10. The buckle of claim 7, wherein the release button and the release member are swingable about an axis perpendicular to the direction of insertion of the tongue elements into the metal body.

11. The buckle of claim 7, wherein the locking plate is mounted on the metal body so that it can swing about an axis perpendicular to the direction of insertion of the tongue elements into the metal body to shift from the locked position to the released position and vice versa.

12. The buckle of claim 11, wherein the release member is provided with at least one retaining formation cooperating with the locking plate to prevent this latter from swinging as a result of displacements of the release button smaller than a predetermined value.

13. Locking device for restraint belts, particularly for motor vehicles safety seats for children, comprising a pair of tongue elements, which can be attached each to a respective belt branch, and a buckle into which the tongue elements can be inserted and releasably locked, the buckle including a metal body and a snap coupling mechanism for releasable connection of the pair of tongue elements to the metal body, wherein the metal body is made as a single sheet metal piece obtained by blanking and folding.
